(19) United States
(12) Patent Application Publication
(10) Pub. No.: US 2004/0153904 A1
(43) Pub. Date: Aug. 5, 2004

(54) [MEMORY ARCHITECTURE AND METHOD FOR REPAIRING A SERIAL ACCESS MEMORY]

(76) Inventors: SHIOU-JE LIN, TAIPEI (TW); JIOU-SZ SHEN, TAIPEI (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 10/605,053

(22) Filed: Sep. 5, 2003

(30) Foreign Application Priority Data
Sep. 9, 2002 (TW) 91120412

(51) Int. Cl. G06F 12/00

(52) U.S. Cl. 714/710

(57) ABSTRACT

A memory architecture and method for repairing a serial access memory is disclosed. The memory architecture has a main memory unit and a redundant memory unit made from an independent memory module. The memory architecture further incorporates other circuits including a data selection unit, a fuse box, a comparable logic unit and a pointer control unit. The comparable logic unit uses a first-in-first-out scheme to access serial data to simplify the circuit. Thus, the invention has lower production costs and greater design flexibility.

### CROSS REFERENCE TO RELATED APPLICATIONS

This application claims the priority benefit of Taiwan application serial no.91120412, filed on Sep. 9, 2002.

### BACKGROUND OF INVENTION

1. Field of Invention

The present invention relates to a memory architecture and method for repairing a serial access memory. More particularly, the present invention relates to a memory architecture and method for repairing a serial access memory by providing a control interface circuit and redundant memory.

2. Description of Related Art

Following recent advances in electronic technology, information exchange between users is increasingly frequent. Information exchange often requires a large storage medium to hold data. As the access speed of memory has increased, so memory has become an important storage medium in information systems. Due to a rapid increase in the volume of transmitted data, memory with higher access speed and increased storage capacity is in great demand. To increase the production yield of memory and hence reduce production costs, especially for application specific integrated circuit (ASIC) devices, whose overall yield is greatly affected by the corresponding yield of its memory module, a type of memory module with repairing capacity has been developed. This type of the memory module often includes a main memory as well as a redundant memory and peripheral control circuits. The redundant memory can be used to replace a portion of some damaged memory cells inside the main memory.

FIG. 1 is a block diagram showing various components inside a conventional memory module 100 with repairing capability. As shown in FIG. 1, aside from having a main memory 110, the memory module 100 also has a redundant memory 120 and peripheral control circuits, including a fuse box 130, a comparable logic unit 140, and a routing logic unit 150, as shown in FIG. 1. If a portion of the memory cells inside the main memory 110 is damaged, corresponding memory cells in the redundant memory 120 can be used to replace these damaged memory cells.

First, the addresses of the damaged memory cells inside the main memory 110 are registered. Thereafter, fuses inside a fuse box 130, corresponding to the addresses of these damaged memory cells, are cut off by the use of a laser, in order to register these addresses in the fuse box 130. Before accessing the memory module 100 with repairing capacity, the comparable logic unit 140 compares access memory address A with all registered addresses of the damaged memory cells inside the fuse box 130. If one of the addresses of the damaged memory cell matches the access memory address A, the comparable logic unit 140 outputs a repair signal R, indicating that access memory address A is one of the registered addresses of the damaged memory cells and the repair signal R is sent to routing logic unit 150. The routing logic unit 150 then switches an accessing pathway from the damaged memory cell corresponding to access memory address A within the main memory 110 to an address in the redundant memory 120 that corresponds to access memory address A.

FIG. 2 is an example of one registered unit of a conventional fuse box, in which fuses and a comparable circuit for registering the damaged memory addresses are provided. In the example, each address of the damaged memory cell is an 8-bit byte. Hence, there are altogether 16 fuses including F0˜F7 and F0B˜F7B as well as 16 corresponding transistors including N0˜N7 and N0B˜N7B for each address of the damaged memory cell. The fuse box in FIG. 2 also includes a load L and an inverter 210 for outputting a repair signal R1 that indicates the accessed address is the address of a damaged memory cell. The drain terminals of the transistors N0˜N7B are connected to an operating voltage source VDD through their respective fuses F0˜F7B, while the source terminals of the transistors N0˜N7B are connected to the load L. The gate terminals of the transistors N0˜N7 are connected to respective bits A0˜A7 of the access memory address. Similarly, the gate terminals of the transistors N0B˜N7B are connected to respectively bits A0B˜A7B of the access memory address.

Assuming the memory cell in the main memory 110 has an address from a low bit to a high bit is 00010001 and is a damaged memory cell, a laser can be used to cut off the fuse F0B, F1B, F2B, F3, F4B, F5B, F6B and F7. The address of the damaged memory cell “00010001” is then registered in the fuse box. When the bits A0˜A7 of the access memory address A are 00010001, that is, identical to the address of the damaged memory cell, the gates of the uncut fuse of the transistors N0, N1, N2, N3B, N4, N5, N6 and N7B are applied with a low voltage potential and not turned on. Hence, the repair signal terminal R1 output from the fuse box possesses a high voltage potential. When the bits A0˜A7 of the access memory address A are not the registered address “00010001” in the fuse box, the repair signal terminal R1 output from the fuse box is in a low voltage potential. Through such a mechanism, the status, i.e. damaged or not damaged, the memory cell of a requested access memory address is indicated. Obviously, if the number of damaged memory addresses that can be held within the fuse box 130 is greater than one, the circuit in FIG. 2 must be correspondingly expanded.

When the aforementioned memory module 100 with repairing capacity is applied to an ASIC device that operates in first-in-first-out (FIFO) serial data accessing mode, the following disadvantages are apparent in the conventional architecture: 1. The comparable logic unit 140 needs to compare the access memory address with all the addresses of the damaged memory cells registered by the fuse box 130. Hence, the comparable logic circuit 140 is typically complicated and consumes a lot of power. 2. Since the access pathway is changed through the addressing logic unit 150 only after the comparable logic unit 140 receives the access memory address and compares it with all the addresses of damaged memory cells registered by the fuse box 130, access performance for the memory module 100 is restricted. 3. ASIC design that uses a memory module 100 with repairing capacity is normally developed by using a memory cell library containing programs written for a memory design having embedded repairing functions. As such, the development time for an ASIC design possessing a memory module 100 with repairing capacity is usually longer than for an ASIC design that has a memory module 100 without repairing capacity. In addition, such ASIC designs possessing a memory module 100 with repairing capacity are relatively less flexible than those without repairing capacity. Furthermore, ASIC designs that have memory modules 100 without repairing capacity are much easier to be obtained in the art, as opposed to those with repairing capacity, which reduces the work and costs involved in such designs.

### SUMMARY OF INVENTION

Accordingly, one object of the present invention is to provide a memory architecture and method for repairing a serial access memory. As compared with the conventional memory modules in integrated circuit devices, the comparable logic unit used in the memory module according to the present invention is simplified. Also the present invention is not required to compare an access memory address with all the addresses of the damaged memory cells. In addition, the development time, flexibility of applications, efforts and costs for the integrated circuit design are significantly improved.

One further object of the present invention is to provide a memory architecture and method for repairing serial access memory. The memory module is implemented by a standard memory module design without a repair function, which is easily found in a cell library. In an alternative embodiment of the invention, the mechanism is used in an application specific integrated circuit (ASIC) device. A control interface circuit and redundant memory are further provided in the memory module to implement the repair function for the memory module in the integrated circuit device.

To achieve these and other advantages and in accordance with the purpose of the invention, as embodied and broadly described herein, the invention provides an integrated circuit with an application circuit and a memory module. The memory module includes a main memory, a redundant memory and a control interface circuit. The control interface circuit is used to store a plurality of addresses. Each of the addresses corresponds to a damaged memory cell in the main memory. When the memory module is accessed by an access address, the control interface circuit issues a pointer address to point to the corresponding address in the stored addresses in the control interface circuit and compares the address corresponding to the pointer address and the access address. If the address corresponding to the pointer address is equal to the access address, data accessed by the access address from the memory module is read out from the redundant memory, instead of the main memory.

In an alternative embodiment of the above-mentioned integrated circuit, when the data accessed by the access address from the memory module is read out from the memory address of the redundant memory, the memory address corresponds to the pointer address issued by the control interface circuit.

In an alternative embodiment of the above-mentioned integrated circuit, each of the addresses stored in the control interface circuit has a memory address that corresponds to the redundant memory. If the address corresponding to the pointer address is equal to the access address, the data is read out from the memory address of the redundant memory corresponding to the address.

In an alternative embodiment of the above-mentioned integrated circuit, the control interface circuit comprises a pointer control unit, a fuse box and a comparable logic unit. The pointer control unit, coupled to the redundant memory, is used to generate the pointer address. The fuse box, coupled to the pointer control unit, is used to register the addresses of the damaged cells of the main memory and output one of the addresses according to the pointer address. The comparable logic unit, coupled to the fuse box, is used to compare the access address with the address output from the fuse box, and generate a redundant selection signal if the address corresponding to the pointer address is equal to the access address. If the redundant selection signal is activated, the data accessed by the access address from the memory module is read out from the redundant memory, instead of the main memory.

The control interface circuit further includes a data selection unit coupled to the application circuit, a main memory, redundant memory and a comparable logic unit. If the redundant selection signal is activated, the data accessed by the access address from the memory module is read out from the redundant memory. If the redundant selection signal is not activated, data accessed by the access address from the memory module is read out from the main memory.

The data selection unit includes a multiplexing circuit. The comparable logic unit includes an assembly of NOR gates.

In the above-mentioned integrated circuit, the pointer control unit increments or decrements the pointer address by a step value when the redundant selection signal is set. In a preferred embodiment, the step value is one.

To realize these and other advantages and in accordance with the purpose of the invention, as embodied and broadly described herein, the invention provides a method for an integrated circuit with an application circuit and a memory module. The memory module includes a main memory, a redundant memory and a control interface circuit. The control interface circuit is used to store a plurality of addresses, each of which corresponds to a damaged memory cell in the main memory. The method includes assessing the memory module by an access address, issuing a pointer address through the control interface circuit to point to a corresponding stored addresses in the control interface circuit, comparing the address corresponding to the pointer address and the access address. If the address corresponding to the pointer address is equal to the access address, data accessed by the access address from the memory module is read out from the redundant memory.

In an alternative embodiment, in the above-mentioned method for integrated circuits, the memory address corresponds to the pointer address issued by the control interface circuit.

In an alternative embodiment, in the above-mentioned method for the integrated circuit, if the redundant selection signal is activated, the data accessed by the access address from the memory module is read out from the redundant memory, if the redundant selection signal is not activated, data accessed by the access address from the memory module is read out from the main memory.

In an alternative embodiment, in the above-mentioned method for the integrated circuit, the pointer address is incremented or decremented by a step value when the redundant selection signal is set. The step value is, for example, one.

It is to be understood that both the foregoing general description and the following detailed description are exemplary, and intended to provide further explanation of the invention as claimed.

### BRIEF DESCRIPTION OF DRAWINGS

The accompanying drawings are included to provide a further understanding of the invention, and are incorporated in and constitute part of this specification. The drawings illustrate embodiments of the invention and, together with the description, serve to explain the principles of the invention.

FIG. 1 is a block diagram showing various components inside a conventional memory with fault-repairing capability.

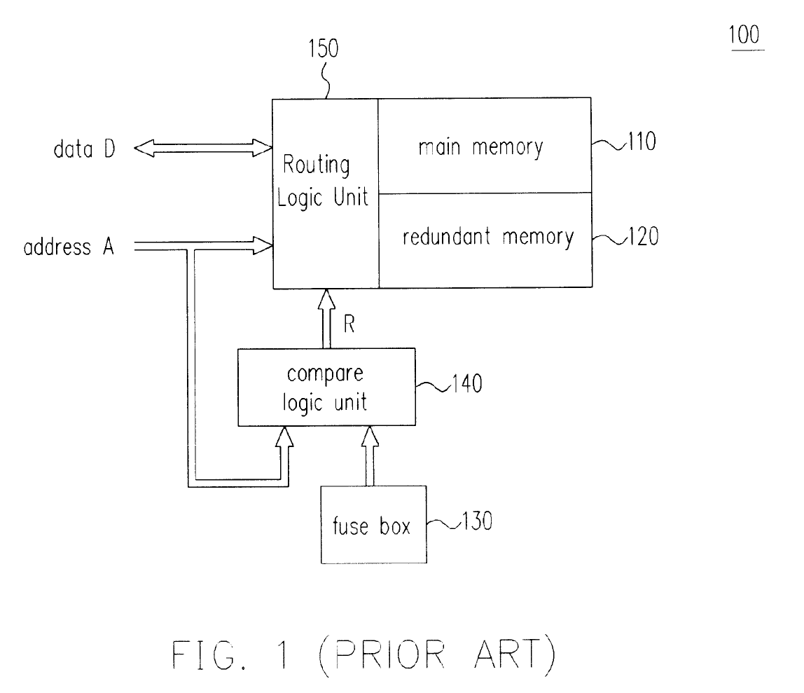

FIG. 2 is an example of a conventional system with a fuse link and comparable circuit registering damaged memory addresses.

FIG. 3 is a block diagram of a memory structure with fault-repairing capability according to one preferred embodiment of this invention.

### DETAILED DESCRIPTION

Reference will now be made in detail to the present preferred embodiments of the invention, examples of which are illustrated in the accompanying drawings. Wherever possible, the same reference numbers are used in the drawings and the description to refer to the same or like parts.

The invention provides a memory architecture and method for repairing a serial access memory. The memory module is implemented by a standard memory module design without a repair function, easily found and obtained in a cell library provided by some resources without any cost. In an alternative embodiment of the invention, the mechanism is used in an application specific integrated circuit (ASIC) design having a memory module design without repair function. A control interface circuit and a redundant memory are further provided in the memory module to implement the repair function for the memory module in the ASIC device.

As compared with conventional memory modules in integrated circuit devices, the comparable logic unit used in the memory module of the preferred embodiment is simplified. The access memory address does not have to be compared with all the addresses of the damaged memory cells registered by the fuse box. Hence, the comparable logic circuit occupies a relatively lower layout area and consumes less power than a conventional comparable logic unit. In addition, since the memory module is implemented by a standard memory module design without a repair function, the development time, flexibility of applications and effort costs of the integrated circuit design are significantly improved.

An ASIC device is explained in the following embodiment accompanying the corresponding drawing. However, it is apparent to those skilled in the art that other kinds of integrated circuits can be made with the mechanism of the present invention without departing from the scope or spirit of the invention.

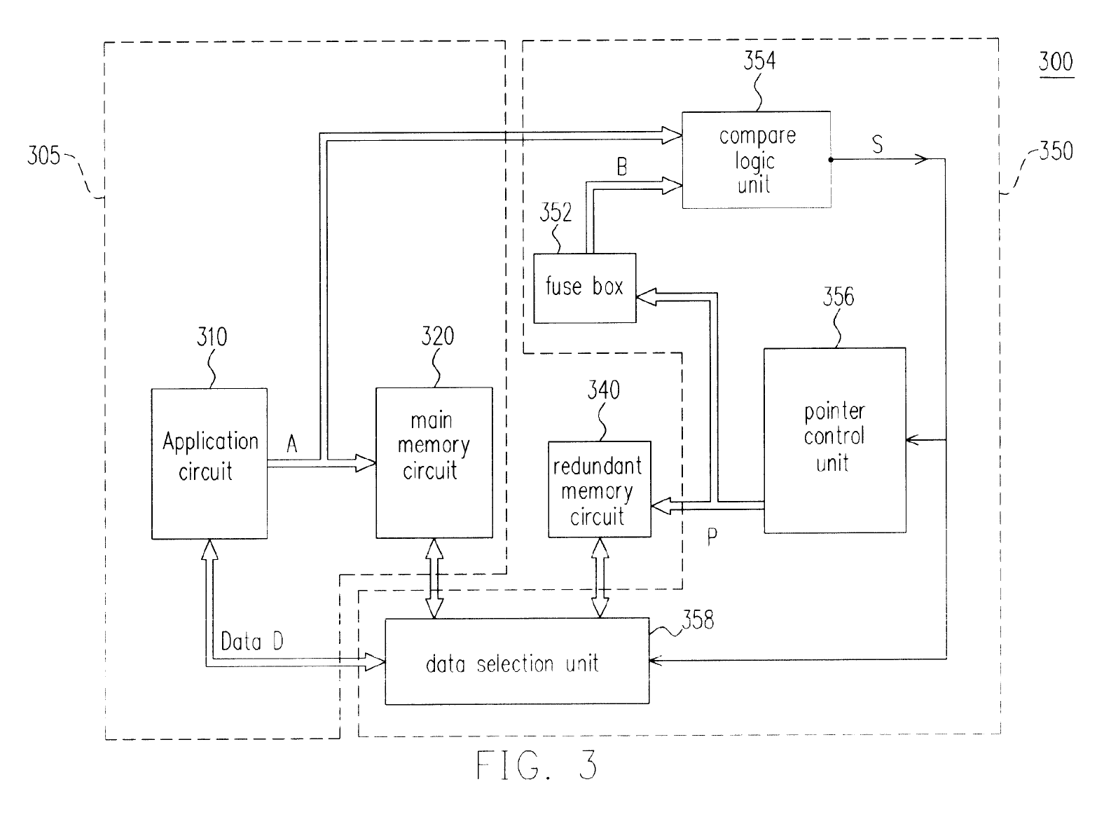

Refer to FIG. 3, which shows block diagrams of an ASIC device 300 of a preferred embodiment for the present invention. The ASIC device 300 includes an application circuit 310 and a main memory 320, which is an embedded memory of a memory module for the ASIC device 300. The design 305 for the ASIC device 300 includes an application circuit 310 and a main memory 320 without a repair function that can be easily found and obtained in a cell library provided by some resources with minimal cost. A redundant memory 340 and a control interface circuit 350 are further provided to implement the repair function in the ASIC device 300. That is, in the preferred embodiment of the invention, the repair function is completed by such a mechanism including the redundant memory 340 and a control interface circuit 350. A memory module in the ASIC device 300 includes the main memory 320, the redundant memory 340 and the control interface circuit 350.

The control interface circuit 350 includes a fuse box 352, a comparable logic unit 354, a pointer control unit 356 and a data selection unit 358. The control interface circuit 350 is implemented by full CMOS process design, which significantly reduces power consumption during operation. On the other hand, the prior art device is implemented by N CMOS design.

To reduce production costs, provide more design flexibility and boost overall performance, the ASIC device 300 does not use a design cell library with embedded repairing functions. In this invention, the main memory 320 and the redundant memory 340 are designed separately. In general, a design cell library with embedded repairing function needs to establish a set of specifications before carrying out the design by an external institution. Hence, development time is usually long, the application program is usually inflexible and the design cost high. On the contrary, memory designs each without a repairing function but a variety of specifications are plentiful, easy to lay hold of and mostly free. Hence, using independent memory designs to serve as the main memory 320 and the redundant memory 340 and combining these with the control interface circuit 350 in the embodiment, including the fuse box 352, the comparable logic unit 354, the pointer control unit 356 and the data selection unit 358, to form the ASIC device 300 not only lowers production costs, but also increases flexibility in providing the main memory 320 and the redundant memory 340 with a range of storage capacity. This arrangement is especially useful for the ASIC device 300.

As shown in FIG. 3, the main memory 320 is used to access serially transmitted data D according to accessing address A and the redundant memory 340 is used when a portion of memory cells in the main memory 320 are defective. In this case, the pointer control unit 356 issues a memory address chosen by a pointer address P so that data D destined for the damaged memory cell is now stored inside the redundant memory 340. Since the redundant memory 340 is only a backup memory for the main memory 320, redundant memory 340 has a much lower storage capacity than the main memory 320. In general, the ratio of memory cells in the main memory 320 to the redundant memory 340 depends on actual requirements. However, in order to be compatible with the number of addressed damaged memory cells in the main memory 320 registered inside the fuse box 352, each of the addresses in the damaged memory cells registered inside the fuse box 352 corresponds to the address of a memory cell in the redundant memory 340. Consequently, the storage capacity of the redundant memory 340 should at least match the number of addresses of the damaged memory cells inside the fuse box 352.

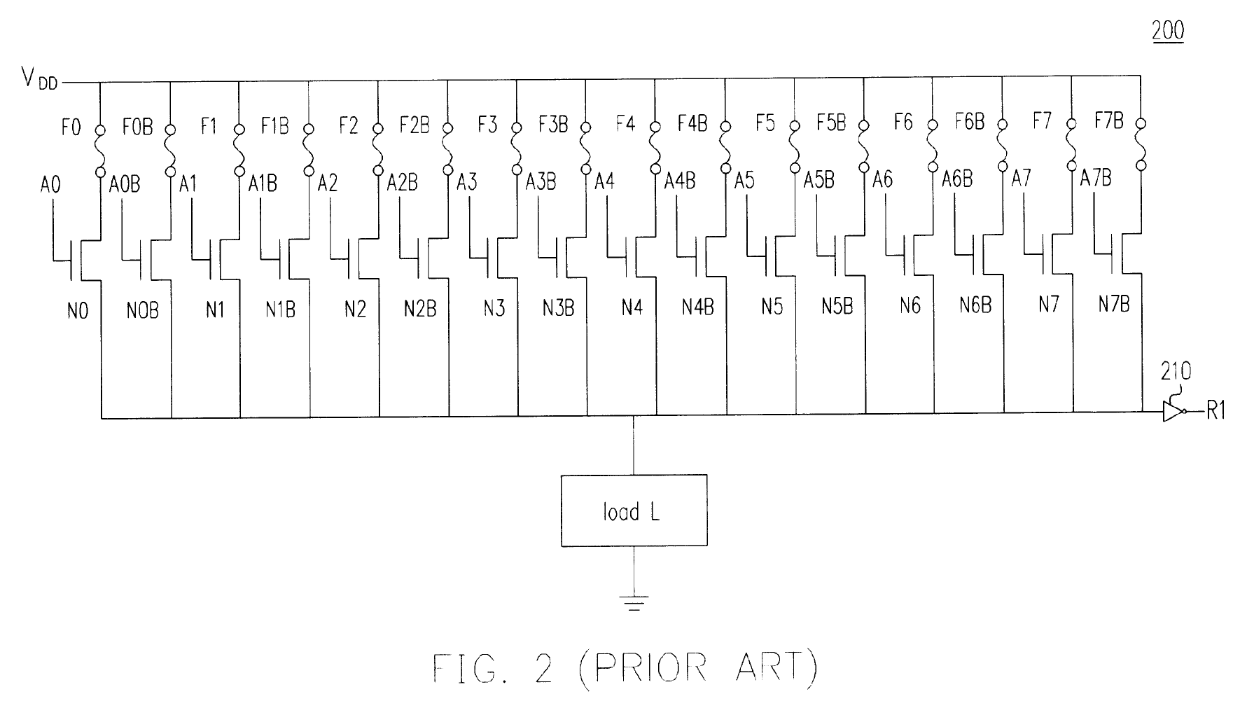

The main memory 320 preferably is a first-in-first-out (FIFO) serial data access memory. Due to the special data accessing characteristics of a FIFO serial data access memory system, the comparable circuit inside the comparable logic unit 354 is very much simplified. For example, as compared to the comparable circuit used in the circuit shown in FIG. 2, there is no need to compare all the registered addresses of the damage memory cells inside the fuse box 352. Only the access address A picked up by the main memory 320 is sequentially compared with the address B of one of the damaged memory cells picked up by the pointer address P issued by the pointer control unit 356. To save power, in an alternative embodiment, the comparable logic unit 354 is fabricated using an assembly of NOR gates. Since a NOR gate only outputs a high potential when the value at both input terminals is identical, NOR gates are particularly suitable for building comparable circuits.

Assume the addresses of the damaged memory cells in the main memory 320 are the memory addresses A1, A2, A3 and A4 respectively. When a laser is used to cut off the fuses inside the fuse box 352, the four addresses A1, A2, A3 and A4 must be sequentially stored inside the fuse box 352. Thereafter, the pointer control unit 356 outputs a pointer address P that points to an address for storing the address A1, so that the fuse box 352 is able to output the address B of the damaged memory cell equal to A1. The address A1 of the damaged memory cell is compared with the access address A via the comparable logic unit 354. If the access address A is found to be equal to A1, that is, the memory cell corresponds to the access address A in the main memory 320 of an damaged memory cell, the comparable logic unit 354, accordingly, generates a redundant selection signal S. The redundant selection signal S instructs data selection unit 358 to divert a data accessing pathway from the main memory 320 to the redundant memory 340. Since the memory address of the redundant memory 340 is controlled by the output pointer address P of the pointer control unit 356, the redundant memory address pointed to by the pointer address P replaces the damage memory address A1 corresponding to the damaged memory cell in the main memory 320.

In addition, the pointer control unit 356 also receives the redundant selection signal S so that the pointer address P is sequentially incremented or decremented by one step value. Preferably, the step value is one unit and points to the address in the fuse box 352 where A2 is stored so that address B of another damaged memory cell output from the fuse box 352 is equal to A2, which corresponds to the updated pointer address P. Similarly, the address A2 of the damaged memory cell is compared with the access address A through comparable logic unit 354. If the access address A is found to be equal to A2, that is, the memory cell that corresponds to access address A in the main memory 320 is a damaged memory cell, comparable logic unit 354 issues a redundant selection signal S. The redundant selection signal S informs the data selection unit 358 so that the data access pathway is redirected to the redundant memory 340. Since the output pointer address P of the pointer control unit 356 already points to the memory address of the redundant memory 340 that corresponds to the address A2 of the damaged memory cell, the memory address of the redundant memory 340 actually replaces the memory address A2 of the damaged memory cell in the main memory 320. Thereafter, the pointer address P is sequentially incremented or decremented by one step value so that the fuse box 352 stores the addresses A3 and A4 as well as any corresponding addresses in the redundant memory 340. Ultimately, the damaged cells inside the main memory 320 are sequentially repaired using corresponding redundant memory addresses.

According to the setting of the redundant selection signal S, the data selection unit 358 is able to select the correct data access pathway between the main memory 320 and the redundant memory 340. The data selection unit 358 can be fabricated using a multiplexing or demultiplexing multiplexer circuit. Obviously, the aforementioned embodiment uses an identical pointer address P to move the pointers that point to the fuse box 352 and the redundant memory 340. However, this is not the only selection. In practice, different pointer addresses may be chosen to move the pointer for the fuse box 352 and the redundant memory 340 as long as one-to-one correspondence is always maintained. Furthermore, when different pointer addresses are used, the pointers need not increment or decrement in synchrony. In other words, one pointer address may increment while another pointer address decrements so long as a one-to-one correspondence relationship is maintained.

Accordingly, this invention has at least the following advantages: When the data access pathway needs to switch from the main memory 320 to the redundant memory 340, the accessing rate is fast because the pointer address P provided by the pointer control unit 356 already points to a corresponding address in the redundant memory 340. Hence, access performance is greatly improved. In addition, since the comparable logic unit 354 only has to compare the access memory address and the addresses of the damaged memory cells in the fuse box 352 sequentially, the comparable logic unit 354 can use a very simple circuit design. Therefore, power consumption is reduced. Furthermore, because independent memory designs are used to form the main memory 320 and the redundant memory 340, chipsets design cost is greatly reduced. In addition, since the capacity of the main memory 320 and redundant memory 340 is scalable and the main memory 320 and redundant memory 340 can be enabled to performing row or by column repairing, design flexibility is as a result increased.

It will be apparent to those skilled in the art that various modifications and variations can be made to the structure of the present invention without departing from the scope or spirit of the invention. In view of the foregoing, it is intended that the present invention covers modifications and variations of this invention provided they fall within the scope of the following claims and their equivalents.

1. A memory architecture used to repair a serial access memory comprising a main memory, a redundant memory and a control interface circuit, the control interface circuit storing a plurality of addresses, each of the addresses corresponding to a damaged memory cell in the main memory,
when the memory module is accessed by an access address, the control interface circuit issuing a pointer address pointing to a corresponding address in the stored addresses in the control interface circuit and comparing the address corresponding to the pointer address and the access address. If the address corresponding to the pointer address is equal to the access address, data accessed by the access address from the memory module is read out from the redundant memory.

2. The memory architecture of claim 1, the data accessed by the access address from the memory module being read out from a memory address of the redundant memory, the memory address corresponding to the pointer address issued by the control interface circuit.

3. The memory architecture of claim 1, each of the addresses stored in the control interface circuit having a memory address that corresponds to the redundant memory, if the address corresponding to the pointer address is equal to the access address, the data read out from the memory address of the redundant memory corresponds to the address.

4. The memory architecture of claim 1, the control interface circuit comprising:
a pointer control unit coupled to the redundant memory, that generates the pointer address;
A fuse box, coupled to the pointer control unit registering the addresses of the damaged cells of the main memory and outputting one of the addresses according to the pointer address;
a comparable logic unit, coupled to the fuse box comparing the access address with the address output from the fuse box, and generating a redundant selection signal if the address corresponding to the pointer address is equal to the access address,
if the redundant selection signal being activated, the data accessed by the access address from the memory module being read out from the redundant memory.

5. The memory architecture of claim 4, the control interface circuit comprising a data selection unit, coupled to the application circuit, the main memory, the redundant memory, the comparable logic unit,
if the redundant selection signal being activated, the data accessed by the access address from the memory module being read out from the redundant memory,
if the redundant selection signal being not activated, the data accessed by the access address from the memory module being read out from the main memory.

6. The memory architecture of claim 5, wherein the data selection unit includes a multiplexing circuit.

7. The memory architecture of claim 4, wherein the comparable logic unit includes an assembly of NOR gates.

8. The memory architecture of claim 4, wherein the pointer control unit increments the pointer address by a step value when the redundant selection signal is set.

9. The memory architecture of claim 8, wherein the step value is one.

10. The memory architecture of claim 4, wherein the pointer control unit decrements the pointer address by a step value when the redundant selection signal is set.

11. The memory architecture of claim 8, wherein the step value is one.

12. The memory architecture of claim 4, wherein the fuse box registers the addresses of the damaged cells of the main memory by cutting off a plurality of fuses in the fuse box by using a laser.

13. The memory architecture of claim 1, wherein the main memory is a first-in-first-out memory circuit.

14. A method for repairing a serial access memory, the memory module comprising a main memory, a redundant memory and a control interface circuit, the control interface circuit for storing a plurality of addresses, each of the addresses corresponding to a damaged memory cell in the main memory,
assessing the memory module by an access address;
issuing a pointer address by the control interface circuit to point to a corresponding one of the stored addresses stored in the control interface circuit;
comparing the address corresponding to the pointer address and the access address, if the address corresponding to the pointer address is equal to the access address, data accessed by the access address from the memory module being read out from the redundant memory.

15. The method of claim 14, wherein the memory address corresponds to the pointer address issued by the control interface circuit.

16. The method of claim 14, wherein
if the redundant selection signal is activated, the data accessed by the access address from the memory module is read out from the redundant memory,
if the redundant selection signal being not activated, the data accessed by the access address from the memory module is read out from the main memory.

17. The method of claim 14, wherein the pointer address is incremented by a step value when the redundant selection signal is set.

18. The method of claim 17, wherein the step value is one.

19. The method of claim 14, wherein the pointer address is decremented by a step value when the redundant selection signal is set.

20. The method of claim 19, wherein the step value is one.

21. The method of claim 14, wherein the main memory is a first-in-first-out memory circuit.
